(19) United States
(12) Patent Application Publication
(10) Pub. No.: US 2024/0116585 A1
(43) Pub. Date: Apr. 11, 2024

(54) WEAR STRIP WITH INSERTS FOR TRACKED VEHICLES

(71) Applicant: Arctic Cat Inc., Thief River Falls, MN (US)

(72) Inventor: Guy L. Sibilleau, Roseau, MN (US)

(21) Appl. No.: 18/377,110

(22) Filed: Oct. 5, 2023

Related U.S. Application Data
(60) Provisional application No. 63/414,212, filed on Oct. 7, 2022.

(51) Int. Cl. B62D 55/10; B62D 55/07; B62D 55/104; B62D 55/24

(52) U.S. Cl. CPC B62D 55/10; B62D 55/07; B62D 55/104; B62D 55/24

(57) ABSTRACT

A wear strip assembly for a snowmobile includes a wear strip comprising a first wear-resistant polymer securable to a skid rail beam of a snowmobile. Inserts are fastened within the wear strip such that lower surfaces of the inserts are substantially flush with a lower surface of the wear strip. Each of the inserts includes a second wear-resistant polymer that is more wear resistant than the first wear-resistant polymer. Between 40 and 50 percent of the lower surface of the portion of the rail is occupied by the inserts. The skid rail beam includes a straight portion and an angled portion, the inserts being positioned along the straight portion.

### PRIORITY CLAIM

This application claims the benefit of U.S. Provisional Application Ser. No. 63/414,212 filed on Oct. 7, 2022, and entitled WEAR STRIP WITH INSERTS FOR TRACKED VEHICLES, which is hereby incorporated herein by reference in its entirety.

### FIELD OF THE DISCLOSURE

This application relates to tracked vehicles and, more particularly, to slide rails for tracked vehicles such as snowmobiles, snowbikes, and tracked ATVs and side-by-sides.

### BACKGROUND

A typical snowmobile includes a track, i.e., a wide belt with outwardly protruding lugs, for providing traction on the snow. One or two rail beams connect to the snowmobile chassis by way of a suspension. Lower edges of the rail beams are covered by rail slides or wear strips that slide against the inner surface of the track such that the portion of the track engaged with the snow is pressed between the wear strips and the snow. The wear strips are made of a low friction and low wear material to facilitate sliding of the track relative to the rail beams.

### SUMMARY

In one aspect of the disclosure, a slide rail assembly for a snowmobile includes a wear strip comprising a first wear-resistant polymer and configured to secure to a rail beam of a snowmobile. A inserts are fastened within the wear strip such that lower surfaces of the plurality of inserts are exposed along a portion of a lower surface of the wear strip. The plurality of inserts includes a second wear-resistant polymer that is more wear resistant and harder than the first wear-resistant polymer. For a portion of the wear strip along the long dimension of the wear strip having the plurality of inserts fastened therein, between 40 and 50 percent of the lower surface of the portion of the rail is occupied by the plurality of inserts.

The wear strip may be configured to secure to a rail beam of a snowmobile, the rail beam including a rear portion and a front portion that is angled with respect to the rear portion, the portion of the wear strip being located exclusively along the rear portion when the wear strip is secured to the rail beam. The rear portion may be straight and along a lower portion of the rail. The wear strip may define a keyway for receiving the rail beam.

The first wear-resistant polymer may be an ultra-high molecular weight polymer with a molecular weight of at least 200,000 atomic mass units. The second wear-resistant polymer may be polybenzimidazole.

A long dimension of each insert of the plurality of inserts may be orientated at an angle of 17 to 27 degrees with respect to a long dimension of the wear strip. A long dimension of each insert of the plurality of inserts may be orientated at an angle of 19 to 25 degrees with respect to a long dimension of the wear strip.

The inserts may longitudinally overlap with one another, a rearward end of one insert being rearward of a forward end of an adjacent insert that is mostly rearward of the first insert.

The wear strip and rail beam may be incorporated into a snowmobile including a chassis, a suspension configured to secure to a chassis of the snowmobile, and one or more rail assemblies each including a wear strip and rail beam. A track encircles the one or more rail assemblies and, in some embodiments, the suspension. The track has metal clips secured thereto and positioned to slide along the wear strip. In some embodiments, no bogey wheels are secured to the rail beam.

The snowmobile may have an electric prime mover. The track has rods separating openings for the drive assembly to engage, each of the rods including a slide clip to ride along the wear strip. The wear strip includes inserts that are discontinuous along the length of at least a portion of the wear strip and longitudinally overlapping from one insert to the next.

### BRIEF DESCRIPTION OF THE DRAWINGS

Preferred and alternative examples of the present disclosure are described in detail below with reference to the following drawings:

FIG. 1 is a side-elevational perspective view of a snowmobile;

FIG. 2 is a partial isometric view of a track, rail beam, wear strip, and track of a snowmobile;

FIG. 3 is a perspective view of a rail beam and suspension of a snowmobile;

FIG. 4A is an isometric view of a wear strip;

FIG. 4B is a cross-sectional view of the wear strip of FIG. 4A;

FIG. 4C is a perspective view of a skid frame with wear strip inserts;

FIG. 5 is a bottom view of a wear strip including inserts;

FIGS. 6A and 6B are cross-sectional views of implementations of a rail beam for a snowmobile.

FIG. 7A is a perspective view of a snowmobile including a suspension in which bogey wheels have been omitted;

FIG. 7B is a perspective view of a snowmobile suspension lacking bogey wheels;

FIG. 8A is an isometric view of a fully clipped inside track portion; and

FIG. 8B is an isometric view of a fully clipped outside track portion.

### DETAILED DESCRIPTION

A wear strip assembly is provided that includes a plurality of inserts comprising a first material positioned along the length of a wear strip comprising a second material. Without being bound to a particular theory, the increased weight and velocity of today's vehicles increases the pressure and velocity of the contact between a metal clip on the track of a vehicle and the wear strip may, which in turn may lead to the melting or deformation of a conventional wear strip material during a low or non-lubricant event (lack of lubricant such as loose snow or ice). The use of inserts comprising a material with a higher limiting pressure velocity rating and hardness at a specific surface area of the wear strip improves the performance of the wear strip assembly. Therefore, the horsepower required to propel the vehicle may be reduced.

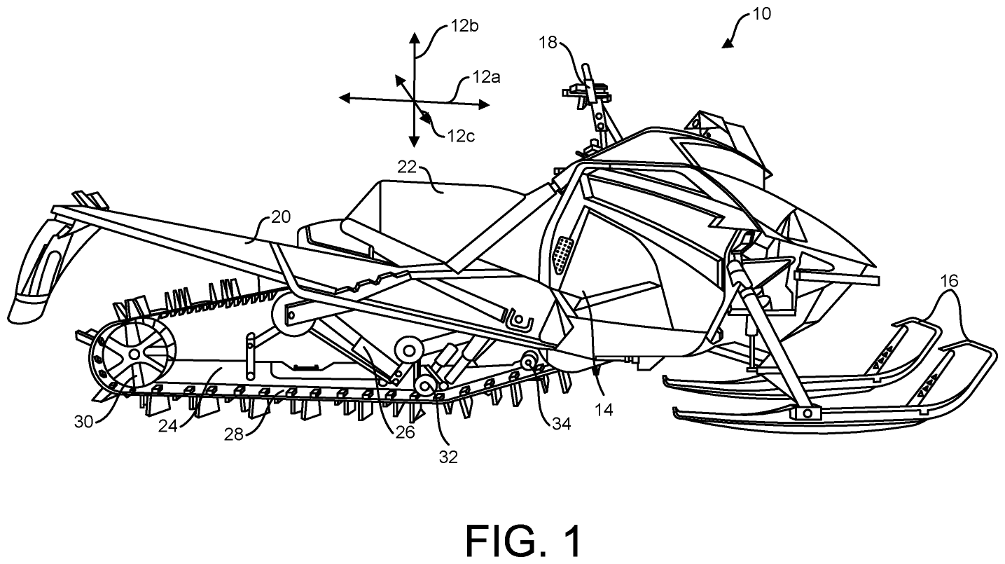

Referring to FIG. 1, a snowmobile 10 may be understood with respect to a longitudinal direction 12a, vertical direction 12b, and transverse direction 12c that are all mutually perpendicular to one another. The longitudinal direction 12a may be substantially parallel to a direction of travel of the snowmobile 10 when directed in a straight line. The vertical direction 12b may be substantially perpendicular to a flat surface supporting the snowmobile 10. As used herein, “substantially” with reference to an angle, e.g., parallel or perpendicular, shall be understood as within 5 degrees of the angle. Although various embodiments are described below with respect to the snowmobile 10, the embodiments may be used in any tracked vehicle, including those that are used on surfaces other than snow and ice. For example, the embodiments disclosed herein may be used in kits for converting ATVs, motorcycles, or automobiles to tracked vehicles or in such vehicles that come with such tracks for part of their drive systems. The vehicles may be propelled with any prime mover such as an internal combustion engine, electric motors, hybrid, etc. The wear resistant properties described below may likewise be advantageous in reducing heat and/or wear caused by dirt, sand, or other contaminants. Such heat and wear may be increased in such instances as the friction between the tracked vehicle skid frame rails and the track may be increased. The embodiments herein help to reduce the friction and also the wear of the components.

The snowmobile 10 includes a chassis 14 that is steered by means of front skis 16 coupled to a handlebar 18 turned by a driver. The chassis 14 further includes a tunnel 20 having a seat 22 mounted thereto on which the driver sits. One or more rail beams 24 are positioned under the chassis and extend under the tunnel 20 in the longitudinal direction 12a. The one or more rail beams 24 are mounted to the chassis 14 by a suspension 26. A track 28 is wrapped around the rail beams 24 and suspension 26 and is driven by an engine (not shown) mounted to the chassis 14. As noted above, the track may be driven by any type of prime mover, such as an electric motor. Circulation of the track 28 is facilitated by two or more rear idler wheels 30 mounted to the one or more rail beams 24 and any number of additional bogey wheels 32 mounted at various positions on the one or more rail beams 24. The bogey wheels are mounted to the rails and have outer wheel surfaces that extend slightly below the rail to engage the track to relieve or remove pressure from the rail on the track. However, the track movement with the bogey wheel is less efficient as it bumps the track away from the rail and results in extra noise. This noise can be especially noticeable with an electric vehicle that does not have combustion engine noise masking the track noise. The bogey wheels may be rotatably secured directly to the rails 24 or may be rotatably secured with spring-loaded arms. A drive shaft with drive cogs (not shown) is secured within the front of the track to drive the track.

Besides the bogey wheels 32 and idler wheels 30, the suspension assembly may include anti-stab wheels 34 at the forward tips of the rail or rails 24. These are positioned to reduce the likelihood of the ends of the rails from entering into one of the track windows during travel through snow and against objects within the snow. Thus, they are somewhat different than the bogey wheels as they are not primarily to reduce friction between the track and the wear strip. As such, the inserts 60 do not negate the need for anti-stab wheels 34.

Removing the bogey wheels may result in more efficient track travel and less noise. Less power is required to drive the track, whether with an internal combustion engine or with an electric motor or other prime mover. The smoother track flow also results in top speed gains.

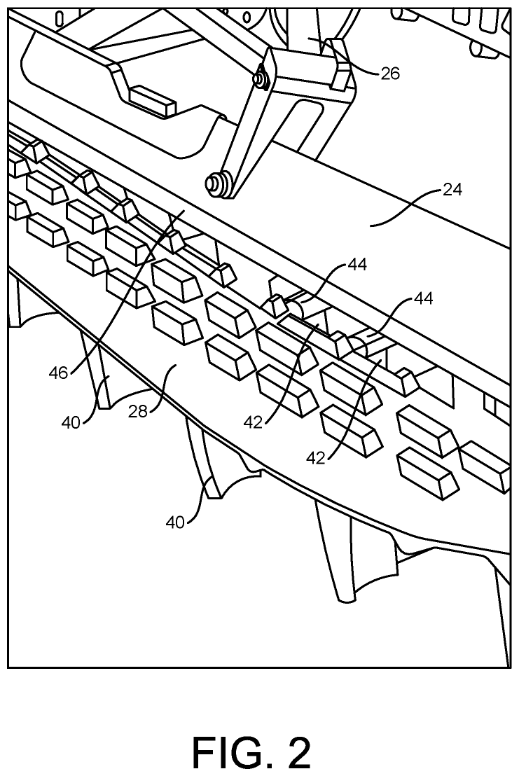

Referring to FIG. 2, the track 28 has lugs 40 projecting outwardly therefrom for gripping snow in order to provide traction. The track 28 may include one or more rows of windows 42 (e.g., holes) for receiving teeth of a drive cog (not shown) driven by the engine. Portions of the track 28 between the windows 42 may have metal clips 44 extending at least partially therearound. These metal clips 44 may slide along the underside of the one or more rail beams 24. Each rail beam 24 may have a wear strip 46 mounted thereto in order to reduce wear caused by the clips 44 and to reduce friction between the rail beam 24 and the clips 44. Although friction between the wear strip 46 and the clips 44 is reduced, friction is still present and can degrade the wear strip 46. This is particularly the case with the illustrated configuration in which a single rail beam 24 is used. The entire weight of the snowmobile 10 and rider that is not carried by the front skis 16 is transferred to the clips 44 by the wear strip 46, resulting in a large amount of heat build-up as the track and associated clips move relative to the rail beam or beams with the associated wear strips.

These portions of the track between the windows 42 may include embedded stiffening rods extending transverse to the longitudinal axis of the snowmobile. The clips at least partially surround the rods within the rubber tracks. Each such portion preferably includes a clip 44, although conventionally a clip is secured to every other rod (half of the rods) along the track. Clip connection to every rod helps to reduce the frictional heating of the clips and track as the embodiments herein include low-friction material to interface with the clips. Thus, the load of the vehicle, driver, and any passenger is dispersed over more clipped portions.

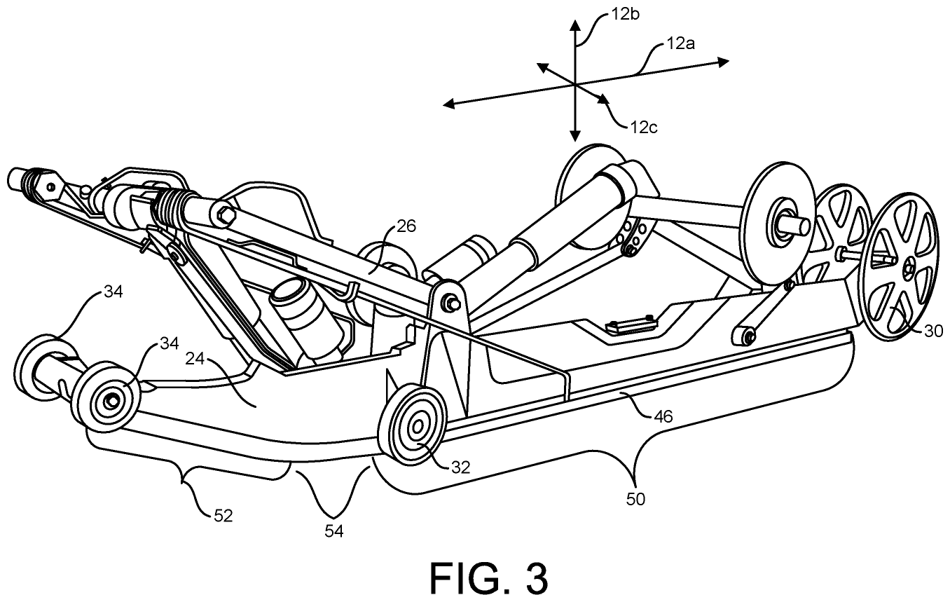

Referring to FIG. 3, the rail beam 24 may have a multi-angled and curved shape including a rear straight portion 50. This portion is typically straight, as noted, but may in fact have some curvature to it depending on intended use and performance desired. However, this is generally the portion of the rail beam 24 that receives the rear track load from the vehicle and driver/passenger regardless if actually completely straight or somewhat curved. The longitudinal direction 12a may be defined as being parallel to the long dimension of the rear straight portion 50. A front portion 52 of the rail beam 24 is angled with respect to the rear straight portion 50 in a plane parallel to the longitudinal direction 12a and the vertical direction 12b (“the longitudinal-vertical plane”). The front portion 52 may be straight or curved. When straight, the front portion 52 may be connected to the rear straight portion 50 by a transition region 54 that is curved in the longitudinal-vertical plane. As is apparent in FIG. 3, the wear strip 46 may extend along lower surfaces of the rear straight portion 50, front portion 52, and any transition region 54.

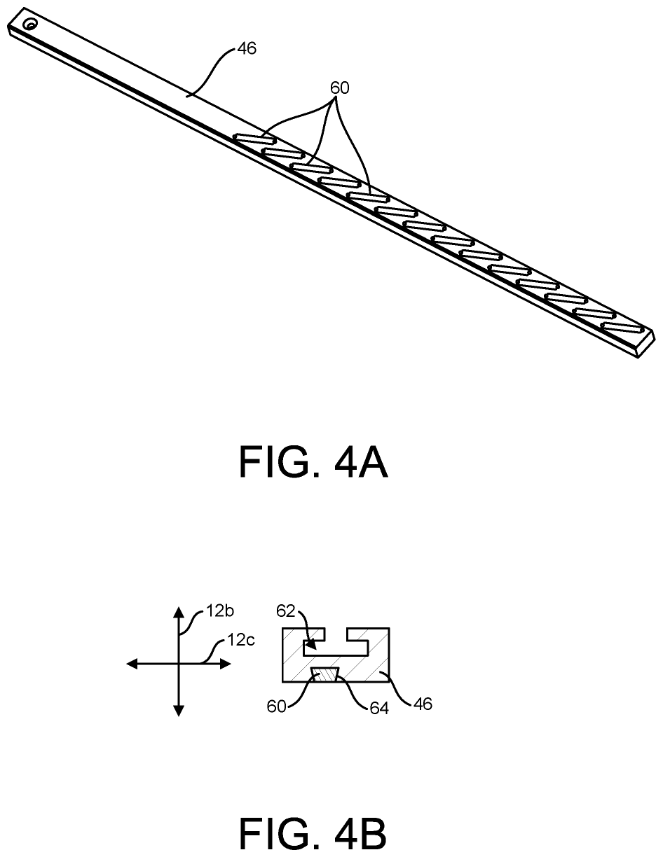

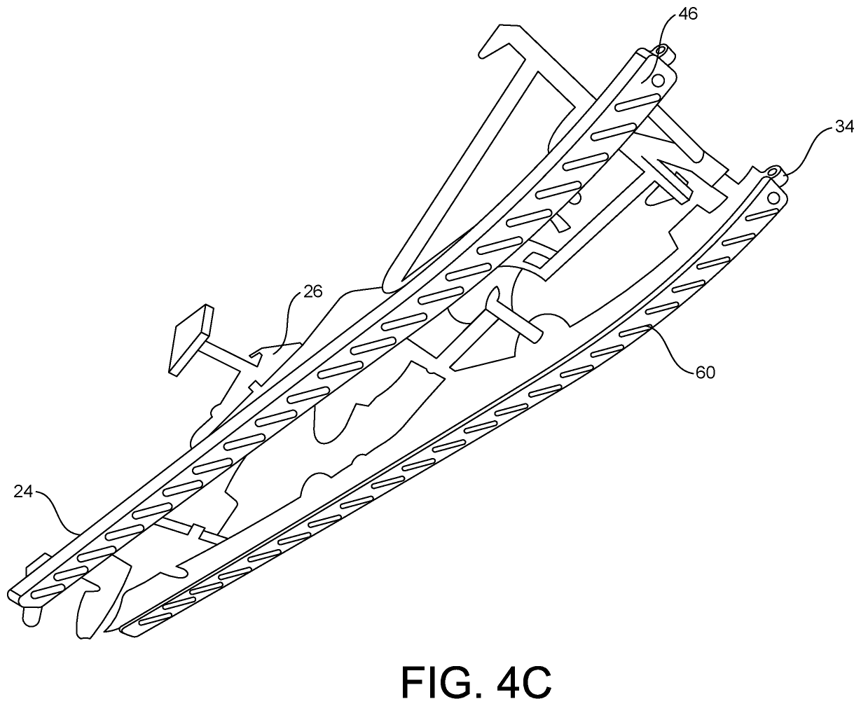

Referring to FIGS. 4A and 4B, the wear strip 46 may have inserts 60 embedded therein. Inserts 60 may have a lower coefficient of friction than the remainder of wear strip 46. The wear strip 46 may include structures to facilitate securement to the rail beam 24, such as a keyway 62 sized to receive a corresponding inverted “T” shape formed on the rail beam 24. The wear strip 46 likewise defines recesses 64 for receiving the inserts 60. The recesses 64 preferably have dovetail or other type engagement to retain the inserts 60 within the strip 46 with a mechanical engagement. Any engaging shape is sufficient. Chemical bonding may also or alternatively engage the inserts 60.

In the preferred embodiment, the inserts extend slightly below the face of strip 46, such as by 5 to 10 thousandths of an inch. This facilitates the strip 46 being molded around the inserts 60 without strip material flashing over the outer surface of inserts 60.

As shown in FIGS. 3 and 4A, the inserts preferably extend only over the lower portion 50 of the rail beam 24. As this is the portion of the rail beam that carries the majority of the rear load of the snowmobile and riders rearward of the skis, this is the portion that generates the most heat due to sliding frictional engagement between the track and the wear strip. However, in alternative embodiments, the inserts may extend further along the length of the wear strips, such as all along the wear strips 46 as illustrated in FIG. 4C.

The inserts 60 are preferably made of a different material than the wear strip 46. For example, the wear strip 46 may be made of ultra-high molecular weight (UHMW) polymer whereas the inserts 60 are made of a more wear-resistant material (e.g., higher hardness and higher limiting pressure velocity (LPV) and/or a material with a higher melting temperature than the wear strip 46. The UHMW polymer may have a molecular weight of between 3.5 and 7.5 million atomic mass units (AMU). For example, TIVAR is a suitable UHMW polymer. The UHMW polymer may have an LPV of between 2900 and 6000 psi-ft/min, such as 5,942 where TIVAR is used. The UHMW polymer may have a Rockwell R hardness between 45 and 60 or between 50 and 60, such as 56 where TIVAR is used. The UHMW may soften substantially at about 175 degrees Fahrenheit.

The inserts 60 may be made of a material that is more wear resistant and harder than the material used for the wear strip 46. The inserts 60 also preferably have a higher melting temperature than the material making up the main body of the wear strip 46. For example, the inserts 60 may be made of polybenzimidazole (PBI), or a PBI blend such as a PBI/Polyetheretherketone (PEEK) blend such as a PBI/PEEK blend which is marketed under the trade name CELAZOLE® TL-60. PBI may provide the advantage of being melt-processable and self-lubricating. Other examples of suitable materials for use in the inserts 60 include TORLON 4203L, TORLON 4275, TORLON 4435, VESPEL SP-21, and VICTREX PEEK 450FC30. The inserts 60 may have an LPV of at least 200,000 psi-ft/min, such as between 200,000 and 300,000 psi-ft/min, such as 250,000 where CELAZOLE® TL-60 is used. The inserts 60 may be made of a material having a Rockwell A hardness greater than 20, such as 24 where CELAZOLE® TL-60 is used.

Although harder and more wear resistant than the wear strip 46, the inserts 60 may be correspondingly more brittle. The wear strip 46 surrounding the inserts 60 may therefore provide improved impact resistance, flexibility, and ductility that improves the longevity of the combined wear strip 46 and inserts 60. The higher LPV of the inserts 60 reduces friction between the inserts 60 and the clips 44 thereby reducing the amount of heat transferred to the wear strip 46. The combined inserts 60 and wear strip 46 therefore enable higher speeds of the track 28 for longer periods of time with less lubrication and cooling from snow or water than could be achieved with a wear strip 46 made exclusively of UHMW polymer.

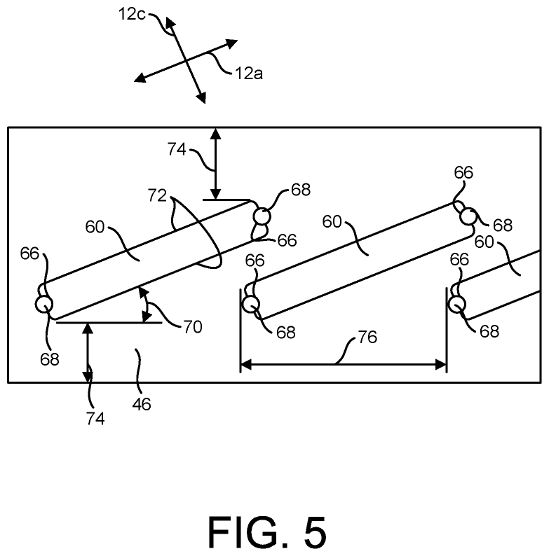

Referring to FIG. 5, in some implementations, the inserts 60 include notches 66 or holes 66 that receive pins 68 secured within a mold. The pins 68 hold the inserts 60 in place while the UHMW material of the wear strip 46, which has a lower melding point than the inserts 60, is injected into the mold. The combined wear strip 46 and inserts 60 are then removed from the mold and pins 68. The mold may have small recesses that also engage the outer face of the inserts 60 as the wear strip material is injected there-around. The recesses help eliminate any flashing material from covering the outer face of the inserts 60.

The inserts 60 may have various properties with respect to the wear strip 46 into which they are secured. These properties may include an angle 70 defined between the longitudinal direction 12a and the straight sides 72 of each insert 60 substantially parallel to the long dimension of each insert 60. The angle 70 may be defined in a plane parallel to the longitudinal direction 12a and the transverse direction 12c (“the longitudinal-transverse plane”). The angle 70 may be between 15 and 45 degrees, between 15 and 30 degrees, or between 20 and 24 degrees in some embodiments. The transverse direction 12c may be defined as being perpendicular to the longitudinal direction 12a and parallel to the lower surface of the wear strip 46 in the rear straight portion 50. Gaps 74 may be present along the transverse direction 12c between the insert 60 and sides of the wear strip 46. The inserts 60 may further be characterized by the placement interval 76 of the inserts 60 along the longitudinal direction 12a. The placement interval 76 may be defined as a distance along the longitudinal direction between a point on one insert 60 and the same point on an adjacent insert 60. For example, the extreme end of one insert 60 may be offset from the extreme end of an adjacent insert 60 by the placement interval 76.

The angle 70, gaps 74, placement interval 76, and the size of the inserts 60 themselves may be selected to achieve a controlled percentage of coverage, i.e., the amount of the area covered by the wear strip 46 that is occupied by the lower surfaces of the inserts 60. In particular, a certain area may be in contact with a clip 44 when sliding across it. A controlled percentage of that area may be occupied by the lower surfaces of the inserts 60. For example, the angle 70, gaps 74, and placement interval 76 may be sized such that when only one insert 60 is on contact with the clip 44, between 40 and 44 percent of the area in contact with the clip 44 is occupied by the lower surface of that insert 60. When the clip 44 is in contact with two inserts 60 at the same time, the percent of the area in contact with the clip 44 that is occupied by the lower surfaces of the two inserts 60 may be between 44 and 50 percent. In one example, the wear strip 46 has a width of about 28.6 mm in the transverse direction 12c, the width of the lower surface of the inserts 60 between sides 72 is 7 mm, the length of the inserts 60 parallel to the sides 72 is 43 mm, the angle 70 is 22 degrees, the placement interval 76 is 38 mm, and the gaps 74 are 6.3 mm wide. In this example, the gap between a side 72 of an insert 60 and the side 72 of an adjacent insert 60 may be about 7 mm, measured perpendicular to the sides 72. This example configuration provides a coverage area of approximately 42 percent when a clip is in contact with one insert 60 and a coverage area of about 46.5 percent when the clip is in contact with two inserts 60. Preferably the coverage of the bottom surface of the wear strip with the inserts, at least in the region of the inserts, is between 40 and 50 percent. The preferred range of values for angle 70 is between 17 and 27 degrees, more preferably between 19 and 25 degrees. In the preferred embodiment, the angle 70 is 22 degrees as noted above.

Preferably the inserts 60 overlap longitudinally such that a clip is always on at least one insert and the transition from one to the next is smooth. The preferred longitudinal overlap is 2.1 mm. Such overlap may be 1 to 4 mm or about 5 percent of the length of an insert. Thus, the rearward end of one insert is further rearward than the forward end of the next insert along the wear strip from front to back. This also provides low friction engagement of the track clips all along the region of the wear strip in which the inserts are embedded. This keeps the temperatures of the track and wear of the wear strip at a minimum for given riding conditions.

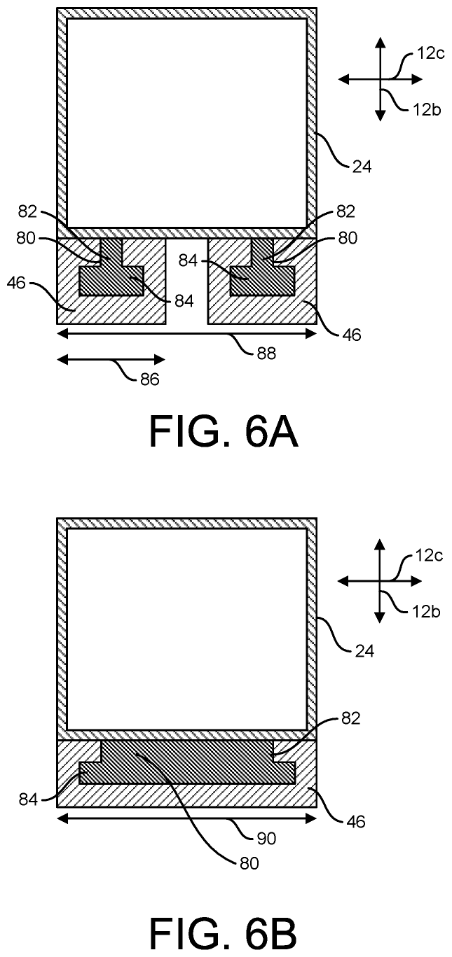

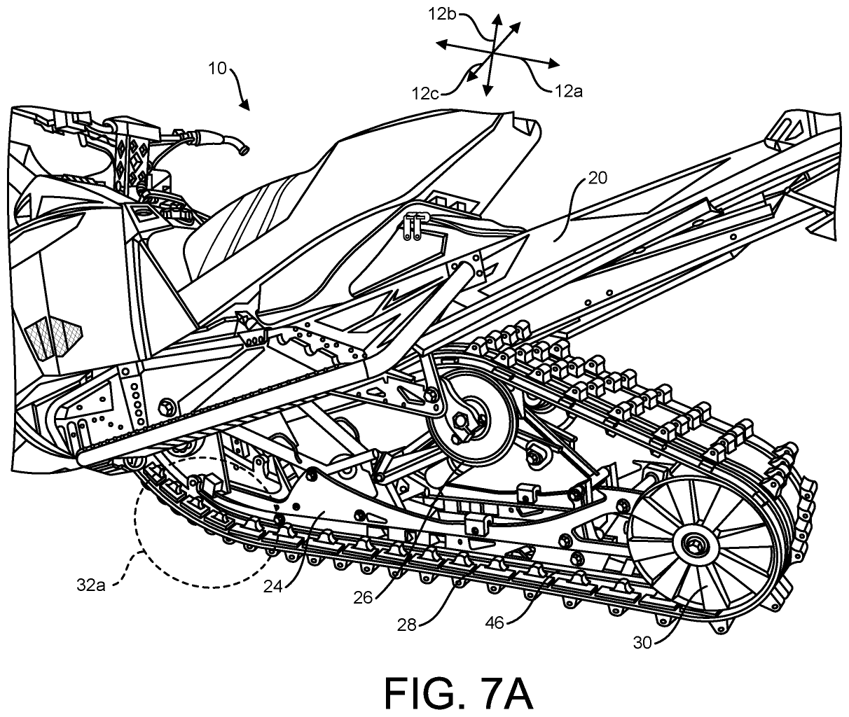

Referring to FIGS. 6A and 6B, the rail beam 24 and wear strip 46 may have various configurations. In particular, the width of the wear strip 46 in the transverse direction 12c may have various values. For example, the wear strip 46 may have a width of 31.75 mm, 38.1 mm, or wider. With a wide-track snowmobile with two separate rails, the wear strip may be about 37 mm wide. As the width of the wear strip 46 increases, the length, width, and/or number of the wears trips 60 may also be increased to achieve the same contact percentage of the clip 44 as described above. The angle 70 may likewise be different as the width of the wear strip 46 increases to achieve the same contact percentage. The inserts may be curved, forked, or most any geometric shape. Ideally the wear strip material is about 50 of the surface or more to provide some good flexibility to add to the robustness of the wear strip. Such other shapes may still provide longitudinal overlap such that the clips are riding on an insert for most or all of the high-load portion 50 of the rail.

Referring specifically to FIG. 6A, in some embodiments, two wear strips 46 secure to a single rail beam 24. Each wear strip 46 may define a T-shaped channel 80 that receives a rail including a vertical portion 82 extending downwardly from the rail beam 24 in the vertical direction 12b and a horizontal portion 84 at the distal end of the vertical portion 82 that extends outwardly from the vertical portion 82 in the transverse direction 12c. Accordingly, the combined wear strip 46 have a width 88 in the transverse direction 12c that is greater than the individual width 86 of each wear strip 46. The wear strip 46 may be offset from one another in the transverse direction 12c such that the width 88 is more than twice the width 86. Referring specifically to FIG. 6B, in other embodiments, a single wear strip 46 is used with a width 90 that is substantially the same as the width of the rail beam 24 in the transverse direction 12c, e.g., between 0.9 and 1.1 times the width of the rail beam 24.

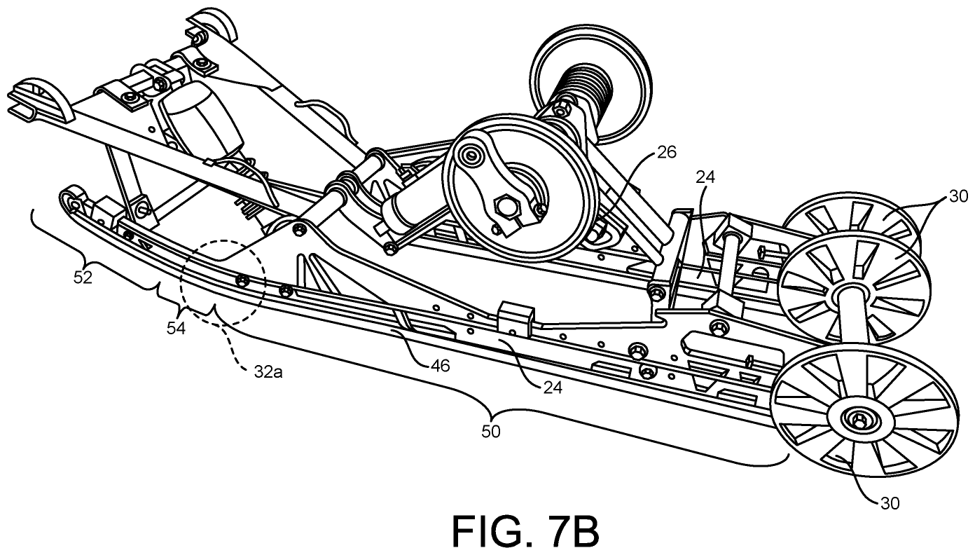

Referring to FIGS. 7A and 7B, the excellent wear resistance and heat tolerance of the wear strip 46 and inserts 60 described herein enables the elimination of some or all bogey wheels 32 (see FIG. 3). For example, region 32a of the rail beam 24 along which a bogey wheel 32 would be positioned may instead rely exclusively on the wear strip 46 to guide and rest on the track 28. Snowmobiles may operate on ice or hard-packed snow or on loose snow, e.g., powder or slush. When operating on ice or hard-packed snow, the track 28 either does not contact or exerts very little pressure on the front portion 52 and transition portion 54. The centrifugal force of the track 28 spinning around the suspension 26 will tend to fling the track 28 away from the front portion 52 and transition portion 54. These effects in combination with the wear resistance and heat tolerance of the wear strip 46 and inserts 60 enable the bogey wheels 32 to be eliminated thereby eliminating mass and friction. When running in loose snow, the track 28 may be pressed against the front portion 52 and transition portion 54. However, the snow also cools the wear strip 46 and clips 44 thereby compensating for the increased pressure.

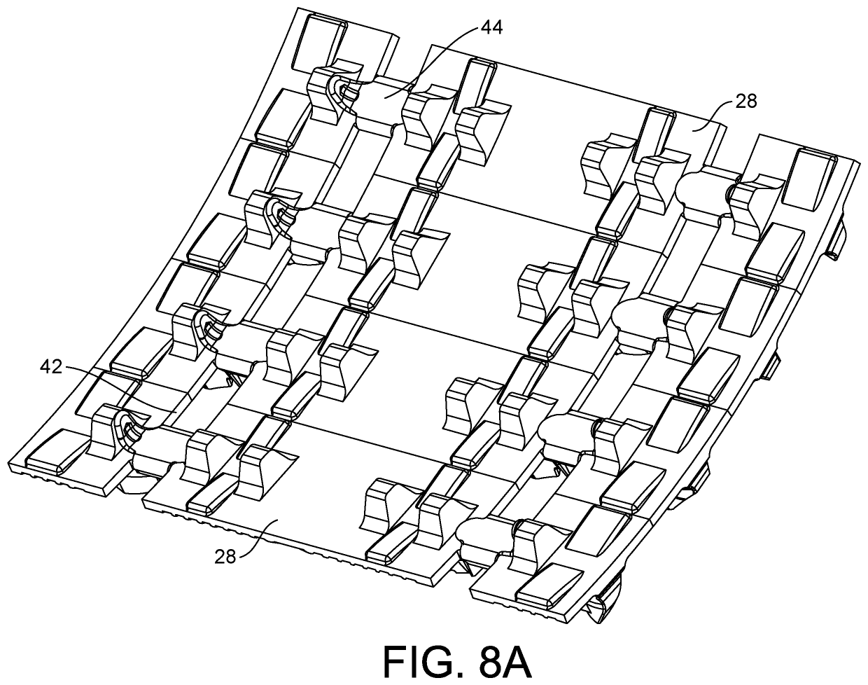

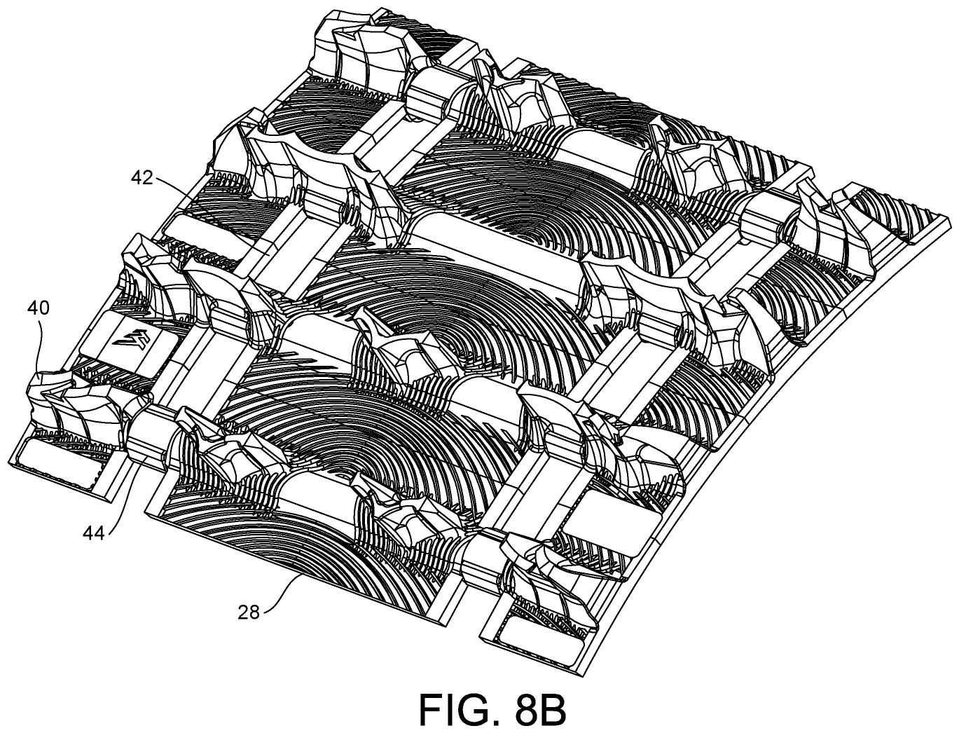

FIGS. 8A and 8B illustrate portions of tracks with fully clipped tracks. Thus, a clip 44 is provided between each of the windows 42 instead of just every other. The low-friction engagement of the inserts 60 allows more clips to be used for a smoother running track with low temperatures. Since the track is fully clipped the pressure on each clip is reduced and there is less contact between the track rubber and the wear strip.

While the preferred embodiments have been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A wear strip assembly for a tracked vehicle comprising:
a wear strip comprising a first wear-resistant polymer and configured to secure to a rail beam of a snowmobile; and
a plurality of inserts fastened within the wear strip such that lower surfaces of the plurality of inserts are exposed along a portion of a lower surface of the wear strip, the plurality of inserts comprising a second wear-resistant polymer that is more wear resistant and harder than the first wear-resistant polymer;
wherein, for a portion of the wear strip along the long dimension of the wear strip having the plurality of inserts fastened therein, between 40 and 50 percent of the lower surface of the portion of the rail is occupied by the plurality of inserts.

2. The wear strip assembly of claim 1, wherein:
the wear strip is configured to secure to a rail beam of a tracked vehicle, the rail beam including a rear portion and a front portion that is angled with respect to the rear portion, the portion of the wear strip including the plurality of inserts being located exclusively along the rear portion when the wear strip is secured to the rail beam.

3. The wear strip assembly of claim 2, wherein the wear strip defines a keyway for receiving the rail beam.

4. The wear strip assembly of claim 1, wherein the first wear-resistant polymer is ultra-high molecular weight polymer with a molecular weight of at least 200,000 atomic mass units.

5. The wear strip assembly of claim 1, wherein the second wear-resistant polymer comprises polybenzimidazole.

6. The wear strip assembly of claim 1, wherein a long dimension of each insert of the plurality of inserts is orientated at an angle of 17 to 27 degrees with respect to a long dimension of the wear strip.

7. The wear strip assembly of claim 1, wherein a long dimension of each insert of the plurality of inserts is orientated at an angle of 19 to 25 degrees with respect to a long dimension of the wear strip.

8. The wear strip assembly of claim 1, wherein the inserts include inserts that longitudinally overlap with one another, a rearward end of one insert being rearward of a forward end of an adjacent insert.

9. An assembly for a snowmobile comprising:
a rail beam configured to secure to a suspension of a snowmobile, the rail beam including a rear portion and a front portion, a lower surface of the front portion being angled with respect to a lower surface of the rear portion;
a wear strip secured to the rail beam over the lower surface of the front portion and the lower surface of the rear portion; and
a plurality of inserts secured within the wear strip such that the lower surfaces of the plurality of inserts are exposed along a lower surface of the wear strip;
wherein the wear strip is formed of a first polymer and the plurality of inserts are formed of a second polymer that is more wear resistant than the first polymer; and
wherein the plurality of inserts longitudinally overlap with one another, a rearward end of a first insert being rearward of a forward end of a second insert that is positioned mostly rearward of the first insert along the longitudinal extent of the wear strip.

10. The assembly of claim 9 wherein, for a portion of the wear strip along the longitudinal dimension of the wear strip having the plurality of inserts fastened therein, between 40 and 50 percent of the lower surface of the portion of the rail is occupied by the plurality of inserts.

11. The assembly of claim 9, wherein the plurality of inserts are positioned only along the rear portion of the wear strip, the rear portion being a generally straight portion substantially parallel to a riding surface.

12. The assembly of claim 9, wherein the first polymer is ultra-high molecular weight polymer with a molecular weight of at least 200,000 atomic mass units and the second polymer is polybenzimidazole.

13. The assembly of claim 9, wherein a long dimension of each insert of the plurality of inserts is orientated at an angle of 17 to 27 degrees with respect to a longitudinal dimension of the wear strip.

14. The assembly of claim 9, further comprising a track entrained around the rail beam, the track including track drive engagement bars and track clips engaged with most of such bars, said track clips interfacing with at least a portion of the wear strip as the track moves past the wear strip.

15. The assembly of claim 9, where the inserts are substantially flush with the bottom of the wear strip.

16. A snowmobile comprising:
a chassis;
a suspension secured to the chassis;
one or more rail assemblies each comprising:
a rail beam configured to secure to the suspension, the rail beam including a straight portion and an angled portion having a lower surface, the lower surface of the angled portion being angled with respect to a lower surface of the straight portion;
a wear strip secured to the rail beam over the lower surface of the angled portion and the lower surface of the straight portion; and
a plurality of inserts secured within the wear strip such that the lower surfaces of the plurality of inserts are exposed on a lower surface of the wear strip, the wear strip being formed of a first polymer and the plurality of inserts being formed of a second polymer that is more wear resistant than the first polymer, the inserts longitudinally overlap with one another, a rearward end of one insert being rearward of a forward end of an adjacent insert; and
a track encircling the one or more rail assemblies and the suspension, the track having slide clips secured thereto and positioned to slide along the wear strip.

17. The snowmobile of claim 16, wherein for a portion of the wear strip along the long dimension of the wear strip having the plurality of inserts fastened therein, between 40 and 50 percent of the lower surface of the portion of the rail is occupied by the plurality of inserts.

18. The snowmobile of claim 16, wherein the track includes openings to receive drive cogs with portions between the windows each having a slide clip thereon.

19. The snowmobile of claim 16, wherein the first polymer is an ultra-high molecular weight polymer with a molecular weight of at least 200,000 atomic mass units and the second polymer comprises polybenzimidazole.

20. The assembly of claim 16, wherein a long dimension of each insert of the plurality of inserts is orientated at an angle of 17 to 27 degrees with respect to a longitudinal dimension of the wear strip.

21. The assembly of claim 16, wherein a long dimension of each insert of the plurality of inserts is orientated at an angle of 19 to 24 degrees with respect to a longitudinal dimension of the wear strip.

22. The assembly of claim 16, wherein no bogey wheels are secured to the rail beam between the straight and angled portions of the rail beam.

23. A snowmobile comprising:
a chassis;
an electric motor secured to the chassis;
a drive assembly coupled to the electric motor;
a suspension assembly secured to the chassis, the suspension assembly including a rail, the rail including a wear strip, wherein the wear strip includes inserts having a lower friction material than the main body of the wear strip, the inserts being discontinuous along the length of at least a portion of the wear strip but longitudinally overlapping from one insert to the next; and
a track entrained around the rail beam, the track including track drive engagement bars and track clips engaged with most of such bars, said track clips interfacing with at least a portion of the wear strip as the track moves past the wear strip.

24. The snowmobile of claim 23, wherein the long dimension of each insert is oriented at an angle between 17 and 27 degrees with respect to a longitudinal direction of the wear strip.

25. The snowmobile of claim 23, wherein the slide clips comprise metal.
